(19) United States
(12) Patent Application Publication
(10) Pub. No.: US 2019/0063921 A1
(43) Pub. Date: Feb. 28, 2019

(54) MEASURING SYSTEM

(71) Applicant: James George, Brooklyn, NY (US)

(72) Inventor: James George, Brooklyn, NY (US)

(21) Appl. No.: 16/114,199

(22) Filed: Aug. 27, 2018

Related U.S. Application Data
(60) Provisional application No. 62/550,698, filed on Aug. 28, 2017.

(51) Int. Cl. G01C 15/00; G01C 3/06; G01B 3/10

(52) U.S. Cl. CPC G01C 15/004; G01C 3/06; G01B 3/1041; G01B 2003/1094; G01B 2003/1092; G01B 2003/1087; G01B 2003/1048; G01B 3/1084

(57) ABSTRACT

An Improved Measuring System structured and arranged to combine a high-quality, high-precision steel tape-measure with both a horizontal and vertical laser level measuring tool, thus combining two essential tools into one compact, convenient device that can be easily clipped to one's belt, or magnetically attached to metal surfaces. Complete with a carrying case, and LED screen which displays the laser acquired measurements, as well as being deal for professional contractors and household do-it-yourselfers, the Improved Measuring System will preferably leave room in the toolbox, allow one to measure without assistance if desired, and deliver accurate and superior results on the jobsite or around the home.

### CROSS-REFERENCE TO RELATED APPLICATION

The present application is related to and claims priority from prior provisional application Ser. No. 62/550,698, filed Aug. 28, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of tape measure devices and more specifically relates to an improved measuring system structured and arranged to combine a high-quality, high-precision steel tape-measure with both a horizontal and vertical laser level measuring tool, thus combining two essential tools into one compact, convenient device that can be easily clipped to one's belt, or magnetically attached to metal surfaces.

### 2. Description of the Related Art

A tape measure or measuring tape is a flexible ruler. It consists of a ribbon of cloth, plastic, fiber glass, or metal strip with linear-measurement markings. It is a common measuring tool. Its design allows for a measure of great length to be easily carried in pocket or toolkit and permits one to measure around curves or corners.

In surveying and construction, the laser level is a control tool consisting of a laser beam projector that can be affixed to a tripod, which is leveled according to the accuracy of the device and which projects a fixed red or green beam along the horizontal and/or vertical axis. Therefore, a need exists for the combination of two essential construction-industry and home-improvement tools into one, the tape measure and level.

Various attempts have been made to solve problems found in tape measure device art. Among these are found in: U.S. Pat. No. 7,299,565 to James D. Marshall et al.; U.S. Pat. No. 6,581,296 to Felix C. Ponce; and U.S. Publication. No. 2004/0118001 to Larry Turpin. This prior art is representative of tape measure devices comprising a laser.

Ideally, an improved measuring system should be user-friendly and safe in-use and yet would operate reliably and be manufactured at a modest expense. Thus, a need exists for an improved measuring system structured and arranged to combine a high-quality, high-precision steel tape-measure with both a horizontal and vertical laser level measuring tool, thus combining two essential tools into one compact, convenient device that can be easily clipped to one's belt, or magnetically attached to metal surfaces and to avoid the abovementioned problems.

### BRIEF SUMMARY OF THE INVENTION

In view of the foregoing disadvantages inherent in the known of tape measure devices art, the present invention provides a novel Improved Measuring System. The general purpose of the present invention, which will be described subsequently in greater detail is to provide an improved measuring system structured and arranged to combine a high-quality, high-precision steel tape-measure with both a horizontal and vertical laser level measuring tool, thus combining two essential tools into one compact, convenient device that can be easily clipped to one's belt, or magnetically attached to metal surfaces.

An improved measuring system comprising: a casing; a laser; a computer member; a display screen; and a power source. The casing includes: a top surface; a bottom surface; at least one side surface connected between said top and bottom surfaces; a first laser aperture; a second laser aperture; a first laser lens; and a second laser lens. Wherein the first laser aperture is located through one of the at least one side surface and adapted to hold a laser lens therein. Wherein the second laser aperture is located through the top surface and adapted to hold a laser lens therein. Wherein the first laser lens is attached to the first laser aperture and adapted to allow a laser beam to be directed therethrough. Wherein the second laser lens is attached to the second laser aperture and adapted to allow a laser beam to be directed therethrough. Wherein the casing forms an interior volume.

Wherein the laser is located within the casing and adapted to create and emit laser beams through the first and second laser apertures and respective lenses. Wherein the computer member is located within the casing, is electronically connected to the laser, and is adapted to compute distances via the laser beams. Wherein the display screen is connected to one of the at least one side surface, is electronically connected to the computer member, and is adapted to display distances computed by the computer member. Wherein the power source is located within the casing, is electrically connected to and provides power to the laser, the computer member, and the display screen.

The present invention holds significant improvements and serves as an Improved Measuring System. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an Improved Measuring System, constructed and operative according to the teachings of the present invention.

FIG. 1 shows a perspective view illustrating an Improved Measuring System having a laser adapted to measure up to fifteen feet according to an embodiment of the present invention.

FIG. 2 is a perspective view illustrating the Improved Measuring System having a magnet and carrying case with the laser adapted to measure up to twenty five feet of the Improved Measuring System according to an embodiment of the present invention of FIG. 1.

FIG. 3 is a perspective view illustrating the laser adapted to measure up to thirty five feet of the Improved Measuring System according to an embodiment of the present invention of FIG. 1.

FIG. 4 is a perspective view illustrating am internal volume housing the internal power source, the laser, and a computer member located within casing, of the Improved Measuring System according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to tape measure device and more particularly to an Improved Measuring System structured and arranged to combine a high-quality, high-precision steel tape-measure with both a horizontal and vertical laser level measuring tool, thus combining two essential tools into one compact, convenient device that can be easily clipped to one's belt, or magnetically attached to metal surfaces. Complete with a carrying case, and LED screen which displays the laser acquired measurements, as well as being deal for professional contractors and household do-it-yourselfers, the Improved Measuring System will preferably leave room in the toolbox, allow one to measure without assistance if desired, and deliver accurate and superior results on the jobsite or around the home.

Generally speaking, the Improved Measuring System comprises a specially designed tool that combine two formerly-separate tools—the tape-measure and the level—into one steel tape-measure which incorporates a laser-level.

The Improved Measuring System may be similar to a construction-grade steel tape-measure and may be produced in a fifteen-foot (15″), twenty-five-foot (25′), and a thirty-five-foot (35′) tape-length, the size of the unit varying, depending on the length of the tape. The Improved Measuring System may indicate feet and inches, as well as measurements in the metric system for global use. The tape's pull-tab may be raised slightly above the bottom of the steel casing, and the bottom of the casing may be perfectly flat. The laser-emitting aperture or lens may likely be centered in the leading edge at the bottom of the casing, as well as atop the unit for both horizontal and vertical measurements. The laser may be powered by a long-life, rechargeable lithium-ion battery, with an adapter and charger-base included. Importantly, the front of the casing may be equipped with a digital, LED readout to indicate the laser measured distance.

A button on the top of the casing may activate the laser and the leveling function, pushing once for horizontal measurement, and twice for vertical. In addition, the Improved Measuring System will feature a magnetic back, so it can be attached to a metal surface when measuring or using the laser, thus offering “an extra hand” on the job. The laser measuring tool may also allow an individual to measure distance without assistance, as the laser may measure said distance, and display the reading on the LED. In other respects the Improved Measuring System may function normally as a locking tape-measure. A convenient carrying case may also be included for safe keeping and easy transport.

The great advantage of the Improved Measuring System, clearly, lies in its ability to take measurements via laser technology and clearly display the measurement results on the LED, as well as its combination of two essential tools into one. With the Improved Measuring System on your work-belt, there may be no need to find and carry a separate level, for you'd have both the tape-measure, and the level, in the same compact, tough and durable instrument. Both tape-measures and levels are essential tools in virtually all the construction trades, and equally essential for do-it-yourself jobs around the house. The Improved Measuring System, by combining a state-of-the-art laser level and measuring tool with a construction-grade steel tape-measure, may lighten the worker's load and toolbox, while providing these essential tools into a single device that clips to his or her belt. Clever in conception and conceived out of an on-the-job need, the Improved Measuring System should find a wide and enthusiastic reception in the construction-industry and home-improvement markets of America and the world.

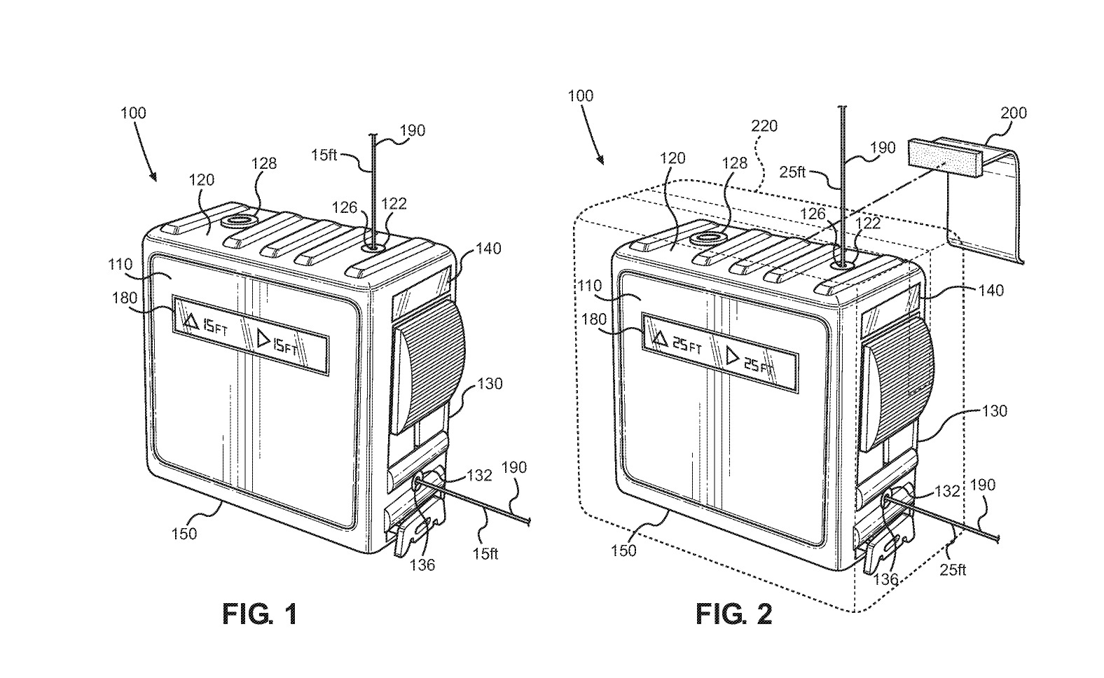

Referring to the drawings by numerals of reference there is shown in FIGS. 1-3, perspective views illustrating improved measuring system 100 according to an embodiment of the present invention.

Improved measuring system 100 comprising: casing 110; laser 400; computer member 420; display screen 180; and power source 450. Casing 110 includes: top surface 120; bottom surface 150; at least one side surface 130 connected between top surface 120 and bottom surface 150; first laser aperture 132; second laser aperture 122; first laser lens 136; and second laser lens 126. Wherein first laser aperture 132 is located through one of at least one side surface 130 and adapted to hold a laser lens therein. Wherein second laser aperture 122 is located through top surface 120 and adapted to hold a laser lens therein. Wherein first laser lens 136 is attached to first laser aperture 132 and adapted to allow a laser beam to be directed therethrough. Wherein second laser lens 126 is attached to second laser aperture 122 and adapted to allow a laser beam to be directed therethrough. Wherein first laser lens 136 and second laser lens 126 are oriented at a 90-degree angle to one another. Wherein casing forms interior volume 480. Wherein casing 110 is formed from steel.

Improved measuring system 100 further comprising magnet 200 attached to at least one side surface 130 and adapted to allow main casing 110 to be releasably attach to a metal surface. The improved measuring system further comprising carrying case 220 adapted to allow main casing 110 to be removably stored therein.

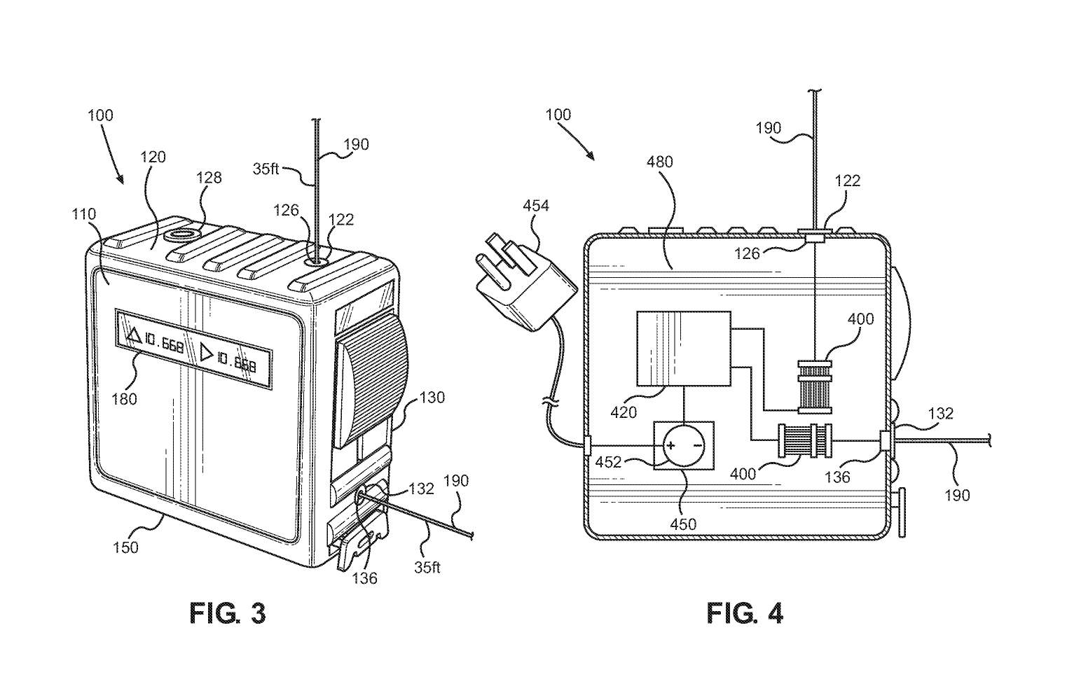

Improved measuring system 100 further comprising level mechanism 140 connected to one of at least one side surface 130 and is adapted to provide a visual display of the level status of casing 110. Wherein level mechanism 140 is formed as digital level mechanism electrically connected to power source 450 and computer member 420. Improved measuring system 100 further comprising control button 128 connected to top surface 120 of casing 110, is electrically connected to power source 450, laser 400 and level, and is adapted to activate laser 400 and level. Wherein control button 128 is adapted to control which of first laser lens 136 and second laser lens 126 laser 400 passes through.

Wherein laser 400 is located within casing 110 and adapted to create and emit laser beams 190 through the first laser aperture 132 and second laser aperture 122 and second laser apertures and respective first laser lens 136 and second laser lens 126. Wherein laser 400 is adapted to measure up to fifteen feet as shown in FIG. 1. Wherein laser 400 is adapted to measure up to twenty five feet as shown in FIG. 2. Wherein laser 400 is adapted to measure up to thirty five feet as shown in FIG. 3.

Wherein the computer member 420 is located within casing 110, is electronically connected to laser 400, and is adapted to compute distances via the laser beams. Wherein computer member 420 is adapted to display distances measured in feet and inches as shown in FIG. 1. Wherein computer member 420 is adapted to display distances measured in metric units as shown in FIG. 3. Wherein display screen 180 is connected to one of at least one side surface 130, is electronically connected to computer member 420, and is adapted to display distances computed by computer member 420. Wherein display screen 180 is formed as a digital light emitting diode screen.

Wherein power source 450 is located within casing 110, is electrically connected to and provides power to laser 400, computer member 420, and display screen 180. Wherein power source 450 is rechargeable battery 452. Improved measuring system 100 further comprising charging base 454 adapted to be electrically connected to an external power source and recharge rechargeable battery 452.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An improved measuring system comprising:
a casing including:
a top surface;
a bottom surface;
at least one side surface connected between said top and bottom surfaces;
a first laser aperture;
wherein said first laser aperture is located through one of said at least one side surface and adapted to hold a laser lens therein;
a second laser aperture;
wherein said second laser aperture is located through said top surface and adapted to hold a laser lens therein;
a first laser lens;
wherein said first laser lens is attached to said first laser aperture and adapted to allow a laser beam to be directed therethrough;
a second laser lens;
wherein said second laser lens is attached to said second laser aperture and adapted to allow a laser beam to be directed therethrough;
wherein said casing forms an interior volume;
a laser;
wherein said laser is located within said casing and adapted to create and emit laser beams through said first and second laser apertures and respective lenses;
a computer member;
wherein said computer member is located within said casing, is electronically connected to said laser, and is adapted to compute distances via said laser beams;
a display screen;
wherein said display screen is connected to one of said at least one side surface, is electronically connected to said computer member, and is adapted to display distances computed by said computer member; and
a power source;
wherein said power source is located within said casing, is electrically connected to and provides power to said laser, said computer member, and said display screen.

2. The improved measuring system of claim 1, wherein said casing is formed from steel.

3. The improved measuring system of claim 1, wherein said power source is a rechargeable battery.

4. The improved measuring system of claim 1, wherein said display screen is formed as a digital light emitting diode screen.

5. The improved measuring system of claim 3, further comprising a charging base adapted to be electrically connected to an external power source and recharge said rechargeable battery.

6. The improved measuring system of claim 1, further comprising a level mechanism connected to one of said at least one side surface and is adapted to provide a visual display of the level status of said casing.

7. The improved measuring system of claim 6, wherein said level mechanism is formed as a digital level mechanism electrically connected to said power source and said computer member.

8. The improved measuring system of claim 7, further comprising a control button connected to said top surface of said casing, is electrically connected to said power source, said laser and said level, and is adapted to activate said laser and said level.

9. The improved measuring system of claim 8, wherein said control button is adapted to control which of said first and second lens said laser passes through.

10. The improved measuring system of claim 1, wherein said first and second lenses are oriented at a 90 degree angle to one another.

11. The improved measuring system of claim 1, further comprising a magnet attached to said at least one side surface and adapted to allow said main casing to be releasably attach to a metal surface.

12. The improved measuring system of claim 1, further comprising a carrying case adapted to allow said main casing to be removably stored therein.

13. The improved measuring system of claim 1, wherein said laser is adapted to measure up to fifteen feet.

14. The improved measuring system of claim 1, wherein said laser is adapted to measure up to twenty five feet.

15. The improved measuring system of claim 1, wherein said laser is adapted to measure up to thirty five feet.

16. The improved measuring system of claim 1, wherein said computer member is adapted to display distances measured in feet and inches.

17. The improved measuring system of claim 1, wherein said computer member is adapted to display distances measured in metric units.
